(19) United States
(12) Patent Application Publication
(10) Pub. No.: US 2009/0029681 A1
(43) Pub. Date: Jan. 29, 2009

(54) ELECTRONIC INFORMATION DEVICE WITH EVENT NOTIFICATION PROFILE

(76) Inventors: Richard David Clemow, High Wycombe (GB); Alastair Sibbald, High Wycombe (GB); Robert David Alcock, High Wycombe (GB)

Correspondence Address: DICKSTEIN SHAPIRO LLP, 1825 EYE STREET NW, Washington, DC, 20006-5403, US

(21) Appl. No.: 12/161,952

(22) PCT Filed: Jan. 26, 2007
(86) PCT No.: PCT/GB07/00284

§ 371 Date: Jul. 23, 2008

(30) Foreign Application Priority Data
Jan. 31, 2006 (GB) 0601919.4

(51) Int. Cl. H04M 1/727; H04M 1/00

(52) U.S. Cl. 455/412.2; 455/556.2

(57) ABSTRACT

A mobile electronic device is programmed so that when the device is running a an application and an event occurs that the device needs to notify the user about, then the device alters the visual and/or sonic behaviour of the application according to, a pre-defined event notification profile. The user can select a desired event notification profile from a menu of available profiles stored in the device. For example, the event notification profile could be graphics and/or audio in the application gently fading to an alternative state using a pre-defined transition effect.

### BACKGROUND OF THE INVENTION

1. Field of the Invention

This invention relates to an electronic information device that can provide notifications of events. The term ‘electronic information device’ used in this patent specification should be expansively construed to cover mobile telephones, smart phones, communicators, personal computers, desktop computers and application specific devices. It includes devices able to communicate in any manner over any kind of wireless network, such as GSM or UMTS, CDMA and WCDMA mobile radio, Bluetooth, IrDA etc., as well as over any w/e based network. It includes also devices with no communications capabilities. An event may be associated with a communication event, such as an incoming call or connection.

2. Description of the Prior Art

Mobile or portable devices are increasingly becoming combined entertainment and communication devices. Seamless integration of these services is desirable (i.e. the way that device switches from providing entertainment to communications functions should be seamless and elegant). But current designs fail to do this.

This is most apparent when considering what happens when an application is running on a device and an event occurs that the device needs to notify to the user: for example, the mobile device is running a web or WAP browser application and there is an incoming phone call. An example from the non-wireless space would be a PC running a word processor and there is an incoming VOIP call or a diary event reminder. In some mobile devices, the application is abruptly suspended when the notification is played.

It is known to provide a mobile telephone with different ‘profiles’ that determine the behaviour of the telephone. For example, a ‘meeting’ profile might turn off the ringer and divert all calls immediately to voice mail. An ‘outdoors’ profile might set the ringer volume to maximum. However, these profiles are not meant to alter the visual and/or sonic behaviour of an application running on the telephone.

### SUMMARY OF THE INVENTION

The present invention is an electronic information device programmed so that when the device is running an application and an event occurs that the device needs to notify a user about, then the device alters the visual and/or sonic behaviour of the application according to a pre-defined event notification profile, in which the user can select a desired event notification profile from a menu of available profiles stored in the device.

An ‘application’ is a program that presents visual and/or sonic behaviour in normal operation, such as a browser, word processor, gaming application, messaging application, email application, music player, video player.

For example, the event notification profile could define how the application behaves (e.g. appears) when there is an incoming phone call; it could define that the call instantly stops, suspends or pauses the application.

The event notification profile could also or alternatively define that graphics and/or audio in the application gently fade to an alternative state or gracefully transition with a pre-defined visual and/or sonic transition effect. An event notification window or icon could gracefully fade in or appear in some other user-defined visual and/or sonic manner.

The event notification profile could also include the selection of a particular a 3D sonic effect to occur in pre-defined situations.

Different event notification profiles could apply to:
different applications
different times of day
different environmental factors
different physical or logical locations.

The menu of available profiles (or themes) can enable the user to readily define how a particular visual and/or sonic behaviour of any particular application alters when an event needs to be notified; this may also be as a function of time, environmental factors, location, and may vary with different pre-defined event types.

The event notification profile could be downloaded from a remote service and may include or reference graphical and/or audio content (and be downloadable in the same way that a mobile telephone ringtone/wallpaper etc is downloadable).

### DETAILED DESCRIPTION

If a user is using a mobile phone device for entertainment, for example watching a video, listening to music or playing games (the “application”), the telecoms “receive” functions will usually be active so that phone calls or messages can be received. When an incoming call or message arrives, there needs to be some method of telling the user about this “event”. Other types of event could also occur, for example, a scheduling event from personal organiser software, to tell the user than an appointment is due. This invention describes a novel way to handles these events and the subsequent behaviour of the mobile device.

The simplest behaviour is to signal the event to the user with an on-screen or audible alert, to allow the user to choose whether to take action (for example, to answer a phone call or read a text message), and to then go into the selected mode. However, this is inelegant and not a very pleasant user experience.

This invention is a design that allows the user to select a “profile”, which could also be called a “theme”, maybe from a set of preset themes on a menu displayed by the device, to suit their taste. Each theme defines how the mobile device behaves on each event, or even combinations of events. Both the graphical and the audio behaviour of the application (or multiple applications) is controlled by the theme. A theme for a business person might be one where a phone call instantly stops or pauses the application. A theme for a teenager might be one that makes the graphics and audio for an application gentle fade to alternative states, maybe a small graphics picture and quieter audio. With 3D graphics and or 3D audio capability, the sound field associated with the application can be made to move in 3D space to an alternative location, at a certain speed, along a certain path, etc. There can therefore be “smooth” styles, “jazzy” styles, etc.

The theme could also specify how multiple events are handled. Maybe a user might decide that incoming text messages should interrupt music playback, but not a game. Another user might decide that a game could be interrupted, but only by a phone call and not by a text message.

Themes could also be linked to other data, for example time of day or location. A user could define different behaviours for daytime and evenings. Behaviour could be different depending on whether headphones and plugged in or not, or on the headphone/speaker mode that the user has selected. Behaviour could be linked to environmental noise level, as determined by the signal picked up by the microphone. Behaviour could be linked to light level, as sensed by a camera module etc.

Themes could include graphical or audio content, just as a ringtone is “audio content” for an incoming phone call.

Themes could become saleable/downloadable items, just as ringtones are. Downloadable elements of themes could include both the control “logic” of how the device behaves when certain events occur, and also actual audio, graphic or video content itself.

To implement this invention, software in the mobile device would be designed to communicate with all the required functions of the operating system, such as music players, messaging services, camera and microphone signals, etc. The software would therefore have access to the required events and the capability to control the behaviour of applications running on the phone in terms of the video and audio, or indeed any other features, such as camera light and vibrator.

### OTHER EXAMPLE USE-CASES

If the camera sensor detects a low-light condition, and an incoming phone call event occurs (or indeed any other event, as set by the theme), the camera light could be made to turn on, or to flash in some pattern. This would allow the phone to be located easily in the dark.

The length of time that has elapsed since the phone was last used could be used to influence behaviour when certain events occur, as this influences the probability that the device is being held in the hand and hence the likely behaviour required.

The usage pattern of the phone could also be logged and used to influence the behaviour of the phone, allowing the distinction between perhaps an older or younger user. If the phone is used mainly for text messaging, for example, the behaviour desired could be different to that required for an occasional user. A theme could build in this functionality, and be made to effectively adapt to many different use cases.

1. An electronic information device programmed so that when the device is running an entertainment application and a receiving event or a scheduling event occurs that the device needs to notify the user about, then the device alters the visual and/or sonic behaviour of the entertainment application according to a selected event notification profile, wherein the user can select an event notification profile from a menu of available event notification profiles stored in the device.

2. The device of claim 1 wherein one of the available event notification profiles defines that an incoming phone call instantly stops or pauses the entertainment application.

3. The device of claim 1 wherein one of the available event notification profiles defines that graphics and/or audio in the entertainment application gently fade to an alternative state.

4. The device of claim 1 wherein one of the available event notification profiles defines the generation of a 3D sonic effect.

5. The device of claim 1 programmed such that different event notification profiles apply to different applications.

6. The device of claim 1 programmed such that different event notification profiles apply to different times of day.

7. The device of claim 1 programmed such that different event notification profiles apply to different environmental factors.

8. The device of claim 1 programmed such that different event notification profiles apply to different physical or logical locations.

9. The device of claim 1 wherein one of the event notification profiles is downloaded from a remote service.

10. The device of claim 1 wherein one of the available event notification profiles includes or references graphical or audio content.

11. The device of claim 10 wherein the graphical of audio content includes downloadable items.

12. The device of claim 11 wherein the downloadable elements include both the control “logic” of how the device behaves when certain events occur, and also actual audio, graphic or video content itself.

13. The device of claim 1 wherein one of the available event notification profiles defines the visual appearance or sonic behaviour of an event notification window or icon.

14. The device of claim 1, being a portable or mobile device.
